(19) United States
(12) Patent Application Publication
(10) Pub. No.: US 2018/0326881 A1
(43) Pub. Date: Nov. 15, 2018

(54) INFLATABLE SUPPORT BLADDER ASSEMBLY

(71) Applicants: Winsen C ZOUZAL, Detroit, MI (US); Lear Corporation, Southfield, MI (US)

(72) Inventors: Gerald PATRICK, Shelby Township, MI (US); Winsen C ZOUZAL, Detroit, MI (US)

(73) Assignee: Lear Corporation, Southfield, MI (US)

(21) Appl. No.: 15/592,735

(22) Filed: May 11, 2017

(51) Int. Cl. B60N 2/66; A47C 7/46

(52) U.S. Cl. CPC B60N 2/665; A47C 7/467

(57) ABSTRACT

An air bladder assembly for a seat is provided. The air bladder assembly includes a thoracic bladder assembly has an increasing width in the longitudinal direction. A pair of scapular bladders are each positioned on a lateral side of the thoracic bladder assembly and has a tapered width decreasing in the longitudinal direction.

### TECHNICAL FIELD

Various embodiments are directed to an air bladder assembly for a seat back.

### BACKGROUND

In a seated position, an upper region of a person's back, including the thoracic and cervical spinal regions and the scapular region, the supports much of the person's upper body mass.

### SUMMARY

According to at least one embodiment, a seat assembly having a seat back and a central bladder assembly oriented in a thoracic region of the seat back. A pair of side bladders each positioned on a lateral side of the central bladder assembly are oriented in a scapular region of the seat back. An inflation device is in fluid communication with the central bladder assembly and the pair of side bladders. A controller is in electrical communication with the inflation device and is programmed to operate the inflation device to inflate the central bladder assembly. The controller operates the inflation device to inflate the pair of side bladders after initiating inflation of the central bladder assembly.

According to another embodiment, the seat assembly has an upper bladder positioned above the central bladder assembly in an upper spinal region and is positioned laterally between the pair of side bladders. The upper bladder is at least partially oriented in a cervical region of the seat back. The controller is further programmed to operate the inflation device to inflate the upper bladder after initiating inflation of the pair of side bladders.

According to another embodiment, the seat assembly has a lumbar bladder positioned below the central bladder assembly in a lumbar region. The controller is further programmed to operate the inflation device to inflate the lumbar bladder before initiating inflation of the pair of side bladders.

According to another embodiment, the seat assembly has a pair of sacral bladders spaced apart laterally and positioned in the sacral region of the seat back. The controller is further programmed to operate the inflation device to inflate the pair of sacral bladders after initiating inflation of the lumbar bladder.

According to at least one embodiment, an air bladder assembly for a seat is provided. The air bladder assembly has a central bladder assembly with an increasing width in the longitudinal direction. A pair of side bladders are each positioned on a lateral side of the central bladder assembly and each has a tapered width decreasing in the longitudinal direction.

According to another embodiment, the air bladder assembly has an upper spinal bladder positioned above the central bladder assembly.

According to another embodiment, the central bladder assembly has a central region and a pair of lateral regions extending from opposed sides of the central region. The pair of lateral regions are oriented at a non-zero angle to incline laterally.

According to another embodiment, an inner edge of each of the side bladders is positioned adjacent to the central bladder assembly along each lateral side.

According to another embodiment, the central bladder assembly is positioned to be symmetric about a central longitudinal axis of the seat. The pair of side bladders are oriented as mirror images about the central longitudinal axis.

According to another embodiment, an upper bladder is positioned laterally between the pair of side bladders and above the central bladder assembly. The upper bladder is symmetric about the central longitudinal axis.

According to another embodiment, the support surface of each of the side bladders is reclined along the longitudinal direction when inflated.

According to another embodiment, the pair of side bladders are spaced apart by at least 60 millimeters.

According to another embodiment, the air bladder is oriented within the seat back.

According to at least one embodiment, an air bladder assembly for a seat back is provided with a pair of scapular bladders spaced apart laterally. Each scapular bladder has a support surface shaped as an irregular quadrilateral. The pair of scapular bladders are oriented as mirror images of each other about a central longitudinal axis of the seat.

According to another embodiment, each scapular bladder has a lower edge that is more narrow than an upper edge.

According to another embodiment, the lower edge expands in a fore-aft direction a greater distance than the upper edge so the support surface is reclined in the fore-aft direction when inflated.

According to another embodiment, the air bladder assembly includes a thoracic bladder assembly is positioned between the pair of scapular bladders.

According to another embodiment, the thoracic bladder assembly has an increasing width in a longitudinal direction, wherein an inner edge of each of the scapular bladders is positioned adjacent to the thoracic bladder assembly along each lateral side.

According to another embodiment, the air bladder assembly includes a cervical bladder positioned laterally between the pair of scapular bladders.

### BRIEF DESCRIPTION OF THE DRAWINGS

FIG. 1 is a side cross section view of a seat assembly having an inflatable support system according to one embodiment.

FIG. 2 is a front view of the seat assembly and inflatable support system of FIG. 1.

FIG. 3 is a detailed front view of the inflatable support system of FIG. 2.

FIG. 4 is a detailed front view of the scapular bladder.

FIG. 5 is a section view of an inflatable bladder according to one embodiment.

FIG. 6 a perspective view of a seat assembly having an inflatable support system according to another embodiment.

FIG. 7 is a flowchart illustrating a method of controlling an inflatable support system according to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Moreover, except where otherwise expressly indicated, all numerical quantities in this disclosure are to be understood as modified by the word “about” in describing the broader scope of this invention. Practice within the numerical limits stated is generally preferred. Also, unless expressly stated to the contrary, the description of a group or class of materials by suitable or preferred for a given purpose in connection with the invention implies that mixtures of any two or more members of the group or class may be equally suitable or preferred.

With the change from a primarily labor intensive work force to one of desk workers who are seated and using computers, we see an increase in low back pain. This is driving the need for an improvement in the location of the seating support system designed to prevent fatigue and the resultant discomfort. It is believed that supporting the upper back including the cervical and thoracic region of the spine and the scapular regions can reduce forces and support as the upper body mass and transfer the load to a more rigid section of the spinal column. By increasing support of the upper body mass, loads are reduced on the muscles, vertebrae, and discs through the lower spine and pelvic regions. Decreased load reduces fatigue on these areas of the body.

The current prevalent comfort back supporting technology for the furniture and transportation seating focuses only on the lumbar, or lower region of the back to provide relief from fatigue. However, support only for the lumbar region of the back does not prevent pain in the lower back from sitting for longer periods of time. By transferring support from solely located in the lumbar region to now instead support the upper back, it is believed that it may decrease lower back pain.

A comfort seating system for office or home seating furniture or comfort vehicular seating systems, such as in automotive, train, off-road vehicular or aircraft seating, provides supporting pressure along the user's spine between the C4 to the T12 vertebrae, and lesser support in the lumbar region. The region above the T1 vertebrae is the cervical region; and the regions below the T12 vertebrae are the lumbar, sacral and coccyx regions.

There are four main factors that affect subjective comfort: 1) smoothness of the pressure integral; 2) sufficiency of the pressure change; 3) ability to create even pressure for a wide range of anthropometry; and 4) ergonomic/control suitability of actuation. An upper back region comfort seating system design is focused on addressing subjective comfort factors. By supporting the upper back including the cervical region, the thoracic region, and the scapular region, the user's load is transferred from the lumbar region to the upper back, reducing stress and fatigue in the muscles, tendons, and vertebrae of the lower back.

A design feature permits even pressure for a wide range of anthropometry, which can be accommodated by having the degree of pressure adjustable.

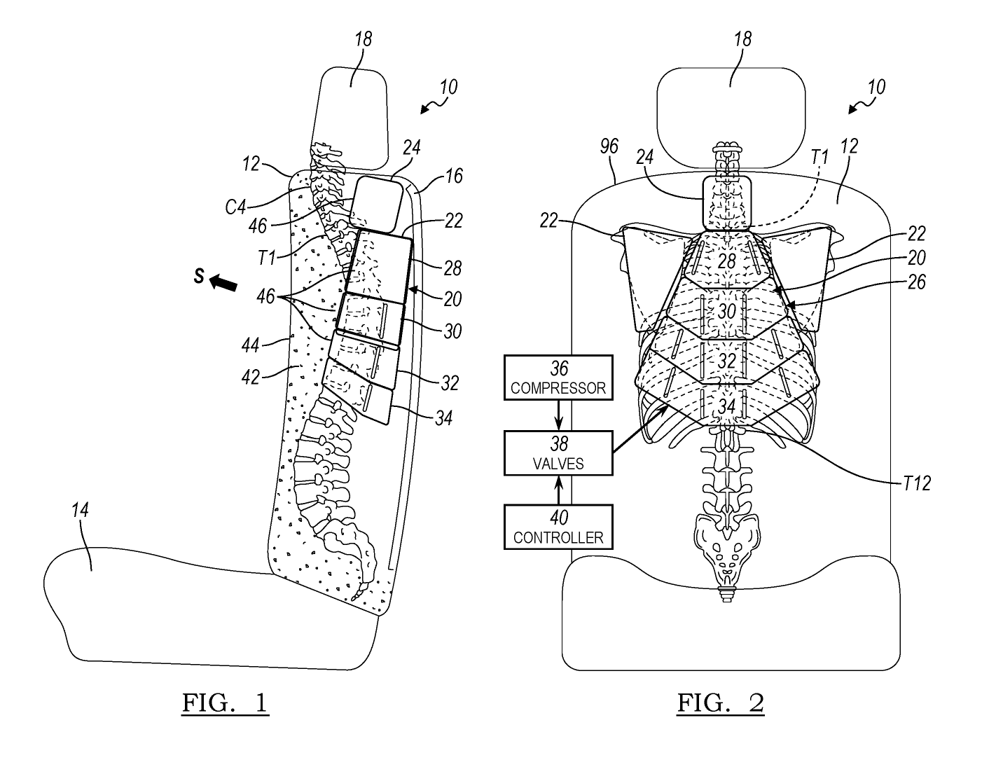

Referring now to FIG. 1, a seat assembly is illustrated and referenced generally by numeral 10. The seat assembly 10 may be a vehicle seat such as for an automobile or an aircraft or any seat assembly that can benefit by an adjustable posture system. The seat assembly 10 has a seat back 12 pivotally mounted to a seat bottom 14. The seat assembly 10 includes a seat frame 16. The seat frame 16 may be formed of stamped metal components and may include a wire mat suspension. A head restraint 18 may be adjustably mounted above the seat back 12. The seat assembly 10 also has an inflatable support system 20 mounted on the frame 16 and positioned in the seat back 12 a distance above the seat bottom 14 to provide support to the upper back and neck of the occupant.

The inflatable support system 20 has an array of bladders that can be each adjustable and individually or collectively inflated providing support at various locations in the seat intended to accommodate different sized and statured individual occupants, as an upper back and neck support system, as shown in FIGS. 1-2. The inflatable support system 20 provides support for the lower neck and back to reduce occupant slouching and prevent the upper back from being rounded. The support system 20 also provides support to the upper spinal region including the cervical-thoracic junction which is an important transition area for maintaining a neutral spine and neutral seating posture of the occupant.

According to one embodiment, the inflatable upper back support system 20 is a power pneumatic system in the seat back 12 which provides support to thoracic and cervical vertebrae, the scapulae, and the posterior rib cage, as shown in FIGS. 1 and 2, to support an occupant and to achieve a proper neutral seating posture.

The inflatable support system 20 has a plurality of support bladders. The support bladders are individually adjustable to achieve an optimum support condition for a variety of postures and occupant sizes. The inflatable support system 20 may mounted to the wire mat suspension on the frame 16 of the seat back 12, or retained in the seat back in a pocket or with any suitable attachment device.

As shown in FIG. 2, the inflatable support system 20 includes pair of scapular support bladders 22 and an upper spine, or cervical support bladder 24. The support system 20 is provided with a thoracic bladder assembly 26. The thoracic bladder assembly 26 has plurality of support bladders 28, 30, 32, 34 illustrated in FIG. 1. While four thoracic support bladders are illustrated, any number or configuration of thoracic support bladders may be utilized.

The inflatable support system 20 includes a compressor 36 for providing a source of pressurized air to valves 38. The valves 38 are controlled by a controller 40. The valves 38 are in fluid communication with each of the bladders in the inflatable support system 20 for controlling pressure and inflation. The controller 40 permits individual adjustment of pressure of each of the bladders in the inflatable support system 20 as specified by an occupant selection or a predetermined pressure setting.

A seat cushion 42 that defines a seating surface 44 is provided over the inflatable support system 20. The seat cushion 42 may define the seating surface 44 supporting the occupant on a seat back 12 or a seat bottom 14. A rear surface of the cushion 42, opposite the seating surface 44, is mounted adjacent the inflatable support system 20. The seating surface 44 of the seat cushion 42 is covered with seat trim, such as fabric or leather.

The inflatable support system 20 may be oriented along the upper region of an occupant's back. In other words, the inflatable support system 20 is sized to support the cervical and thoracic vertebrae and the scapulae located in the upper back of an occupant. The inflatable support system is sized to have the cervical bladder 24 support the cervical vertebrae, such as from the C3 to the C7 vertebrae, as shown in FIGS. 1-2. In another embodiment, the cervical bladder 24 may also support the cervical-thoracic junction, which is an important transition area of the neutral spine. As such, the cervical, or upper spinal bladder 24, may extend from the C5 to T4, for example, to provide support on both longitudinal sides of the cervical-thoracic junction. The cervical bladder 24 may located above the thoracic bladder assembly 26, or may partially overlap the upper thoracic bladder 28, for example.

The inflatable support system 20 may also have a thoracic bladder assembly 26 located between the scapulae, or shoulder blades and between the T1 and T12 vertebrae for an average occupant. The inflatable support system 20 is sized to have a plurality of thoracic air bladders 28, 30, 32, 34 positioned in the thoracic region of the upper back.

The inflatable support system also includes two scapular bladders 22. One scapular bladder 22 is located along each of the lateral sides of the thoracic bladder assembly 26 and oriented to support the shoulder blades of an average occupant to reduce slouching and prevent the upper back from becoming rounded.

The seat back 12 has a seating surface 44 as depicted in FIG. 2. The each of the bladders in the inflatable support system 20 is provided with a support surface 46 within the seat back 12. When inflated the support surfaces 46 of the inflatable support system 20 are reclined relative to the seating surface 44 of the seat back 12 so that inflation of the support bladders provides support in the upward and forward direction S, as shown in FIG. 2. For example, as shown in FIG. 5, the lower edge the scapular bladder 22 expands in a fore-aft direction a greater distance than the upper edge so the support surface is reclined in the fore-aft direction when inflated.

The wedge configuration of support system 20 depicted in FIG. 5 provides support in a forward and upwards direction, as shown by arrow S in FIGS. 1 and 5. The reclined support surfaces 46 lift the occupant's upper back and prevent rounding of the back or slouching. Some prior art designs push downward and compress the occupant's spine and move their head to an anterior, or unnatural forward position. Not only does this promote improper posture, but it moves the occupant's head away from the head restraint 18. In contrast, the support system 20 with reclined support surfaces 46 lifts the spine to reduce slouching and promote a neutral spine, while also helping reduces the occupant's backset, or the distance between the occupant's head and the head restraint 18.

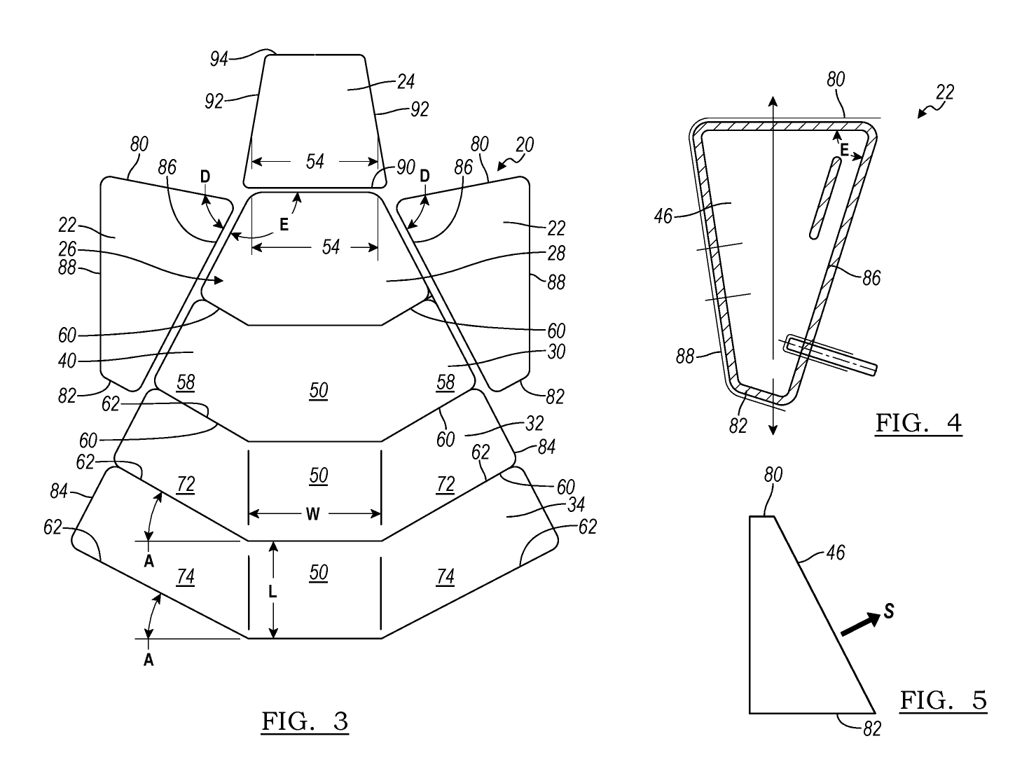

The inflatable support system 20 is also illustrated removed from the seat back 12 in FIG. 3. The thoracic bladder assembly 26 includes an upright column of central air bladder regions 50, each within one of the support bladders 28, 30, 32, 34 for supporting the thoracic vertebrae as depicted in FIGS. 1 and 2. The upright column of central air bladder regions 50 are arranged longitudinally within the seat back 12 and centered along central longitudinal axis of the seat back 12, as shown in FIG. 2, to align with the occupant's spine when properly seated. Each of the central air bladder regions 50 has a length L of approximately one hundred millimeters (100 mm), by example. Further, each of the central air bladder regions 50 has a width W of approximately 60 mm, however other suitable width and length dimensions are possible based on design factors, such as the number of bladders.

As shown in FIG. 3, the first thoracic bladder 28 has an upper width 54 that is the same as the width W of the central bladder regions 50, by example of 60 mm. The first air bladder 28 is tapered outward fit between an occupant's shoulder blades. The first air bladder 28 is provided by a single air bladder region being polygon-shaped. The air bladders 30, 32, 34 are provided below the first bladder 28 and each of the air bladders 30, 32, 34 have a complex shape defined by multiple regions to provide support to the vertebrae and ribs of the occupant.

For example, as shown in more detail in FIG. 3, the second air bladder 30 has a pair of lateral air bladder regions 58 extending from opposed sides of the central air bladder region 50 for supporting the ribs in the thoracic region of an occupant. The each of the lateral air bladder regions 58 is angled relative to the central air bladder region 50 to incline laterally so that each air bladder 30, 32, and 34 fits adequately within the thoracic region. According to one embodiment, the offset angle A of the pair of lateral bladder regions 58 is within a range of fifteen to forty-five degrees. In another embodiment, the lateral bladder regions 58 extend at an offset angle A of approximately thirty degrees, for example. Each of the pair of lateral air bladder regions 58 has an upper width 60 of approximately 35 mm for example, and a lower width 62 of 52 mm thereby defining the lateral bladder regions as irregular quadrilateral shapes, such as trapezoids.

Referring again to FIG. 3, a third thoracic bladder 32 is provided longitudinally below the second air bladder 30. The third air bladder 32 also has a pair of lateral air bladder regions 72 extending from opposed sides of the third air bladder 32 at an angle A, similar to the first pair of lateral air bladder regions 58. The lateral air bladder regions 72 extend a width expanding to approximately 52 mm along the upper surface 60.

With continued reference to FIG. 3, a fourth air bladder 34 is provided longitudinally below the third air bladder 32 and has lateral air bladder regions 74. The lateral air bladder regions 74 are also offset at an angle A from the central bladder regions 50 and have increasing widths to provide comfort and support to the occupant. For example, the lateral air bladder regions 74 extend a width of approximately 69 mm from the central bladder regions 50 along the upper surface 60.

FIG. 4 illustrates the scapular bladder 22 in more detail. The support system 20 includes the pair of scapular bladders 22, each scapular air bladder 22 positioned on a lateral side of the thoracic bladder assembly 26. The scapular bladders 24 are oriented to support the shoulder blades of an average occupant to reduce slouching and prevent the upper back from becoming rounded. The scapular bladders 24 may have a support surface 46 shaped as an irregular quadrilateral. Each scapular bladder 22 has an upper edge 80 that is wider than a lower edge 82. The upper edge 80 may be in the range of 95 mm to 110 mm. As shown in FIG. 3, the upper edges 80 of the pair of scapular bladders 24 are generally parallel. As shown in FIG. 3, the upper edges 80 are collinear.

The scapular bladders 24 have an angled inner edge 86 and outer edge 88. The inner edge 86 angles laterally outward from the top edge at an angle D. The angle D is an acute angle within a range of sixty to eighty degrees. In another embodiment, the angle D is approximately seventy degrees, for example. The angle D may be supplementary to the angle E of the thoracic bladder 28, as shown in FIG. 3. The inner edge 86 may be generally parallel to the lateral edge 84 of the thoracic bladder assembly 26 that has a tapered and expanding width in the longitudinal direction.

The lower edge 82 is narrower than the upper edge 80 and the lower edge 82. The distance between the upper edge 80 and the lower edge 82 in the longitudinal direction is in the range of 140 mm and 180 mm.

As shown in FIG. 3, the pair of scapular bladders 24 are spaced apart by the thoracic bladder assembly 26. In one embodiment, the upper edge 80 of the scapular bladders 24 are spaced apart laterally by at least 60 mm. In another embodiment, the upper edge 80 of the scapular bladders 24 are spaced apart by 100 mm or more. The distance between the outer side edges 88 along the top edges may in the range of 250 mm and 300 mm.

The scapular bladders 24 are oriented as mirror images about the central axis 48 of the seat back 12. As such, inner side edges 86 of the pair of bladders 24 are not parallel. As shown in FIG. 3, the inner side edges 86 of the pair of bladders 24 are oriented at acute angles relative to each other. In one embodiment, the angle D between the inner edges 86 and the upper edge 80 is in the range of twenty to eighty degrees. In another embodiment, the angle formed between the inner edges 86 is approximately thirty-five degrees.

The scapular bladders 24 may have an angled outer edge 88. The outer edge 88 may be angled laterally inward from the upper edge 80. The distance between the outer edges 88 of the pair of scapular bladders 24 at the lower edge 82 is in the range of 220 mm to 280 mm. In at least one embodiment, the lower edge 82 may be defined by the intersection of the side edges 86, 88 so that the scapular bladder 22 is shaped as an irregular triangle.

As shown in the cross section in FIG. 5, the lower edge 82 expands in a fore-aft direction a greater distance than the upper edge 80 so the support surface 46 is reclined in the fore-aft direction when inflated.

Referring again to FIG. 3, the inflatable support assembly 20 also includes an upper spinal bladder 24, or cervical bladder. The cervical bladder 24 supports the cervical vertebrae located above the thoracic vertebrae. The cervical bladder 24 may also be positioned to support the cervical-thoracic junction and may support the upper spinal region from the C5 vertebrae to the T4 vertebrae for example. The cervical bladder 24 is aligned with the central axis of the seat back 12.

As shown in FIG. 3, the cervical bladder 24 has a lower surface 90 that is positioned adjacent the upper surface 54 of the thoracic bladder 28. The lower surface 90 may be generally the same width as the upper surface 54 and central region 50 of the thoracic bladders 30, 32, 34. In at least one embodiment, the lower surface 90 has a width of approximately 65 mm.

In at least one embodiment, the cervical bladder 24 is also positioned above the scapular bladders 24. In another embodiment, the cervical bladder 24 extend below the upper surface 80 to be positioned between the scapular bladders 24 so that side surfaces 92 are adjacent the inner surfaces 86 of the scapular bladders 24. The cervical bladder 24 has a length in the longitudinal direction in the range of approximately 70 mm to 130 mm. The cervical bladder 24 may be an irregular parallelogram, such as a trapezoid so that the upper surface 94 is narrower than the lower surface, as illustrated in FIG. 3. For example, the upper surface 94 of the cervical bladder 24 may be approximately 50 mm. The upper surface 94 may be adjacent a top surface 96 of the seat back 12 and below the head restraint 18.

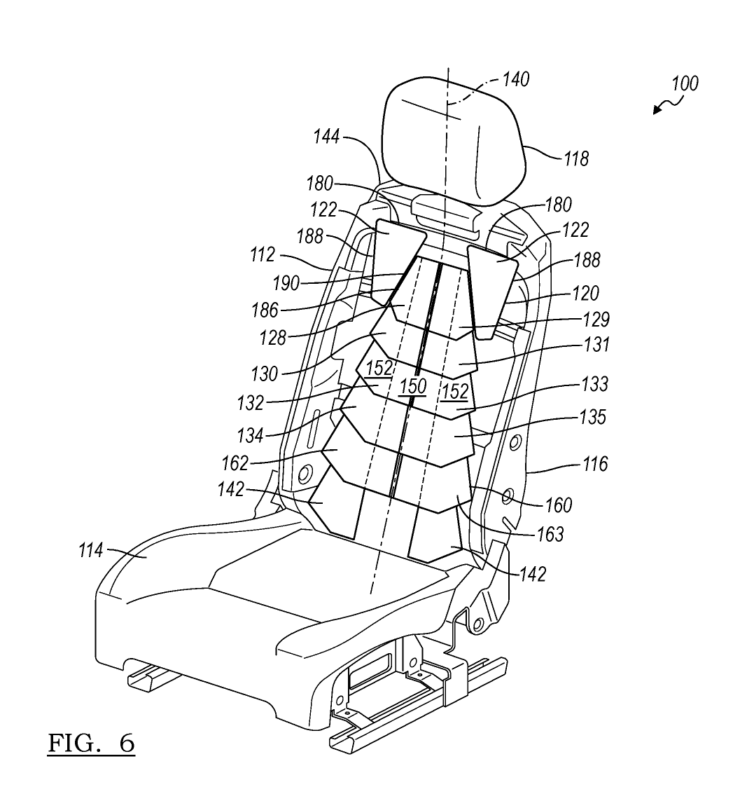

FIG. 6 illustrates a seat assembly referenced by numeral 100. The seat assembly 100 is similar to prior embodiments. The seat assembly 100 has a seat back 112 pivotally mounted to a seat bottom 114. The seat assembly 100 includes a seat frame 116 and a head restraint 18 mounted to the frame 116 to adjust the head restraint 118 relative to the seat back 112. The seat assembly 100 includes an inflatable support system 120 with an arrangement of air bladder assemblies positioned within the seat assembly 100 to contact a targeted region of an occupant. The inflatable support system 120 includes a thoracic bladder assembly 126 located in a thoracic region of the seat assembly 100 to support a thoracic region of an occupant. The thoracic bladder assembly 126 may include thoracic air bladders 128-135. As shown in FIG. 6, each of the thoracic bladder assembly may have left and right bladders that abut along the central axis 140 of the seat back 112 and are mirror images. Each of the left and right bladders permit independent control for targeted support.

The thoracic bladder assembly 126 and each of the thoracic bladders 128-135 have tapered outward width to fit between an occupant's shoulder blades. Each of the thoracic bladders 128-135 has a central bladder region 150 adjacent the central axis 140 of the seat back and lateral air bladder regions 152 extending from opposed sides of the central air bladder region for supporting the ribs in the thoracic region of an occupant. Each of the lateral air bladder regions 152 is angled relative to the central air bladder region 150 to incline laterally so that each air bladder 128-135 fits adequately within the thoracic region. According to one embodiment, the offset angle of the pair of lateral bladder regions 152 is within a range of fifteen to forty-five degrees. In another embodiment, the lateral bladder regions 152 extend at an offset angle of approximately thirty degrees, for example.

Referring to FIG. 6, the support system 120 also includes the pair of scapular air bladders 124, each scapular air bladder positioned on a lateral side of the thoracic bladder assembly 126. The scapular bladders 124 are oriented to support the shoulder blades of an average occupant to reduce slouching and prevent the upper back from becoming rounded. The scapular bladders 124 are shaped as an irregular quadrilateral. The scapular bladder 124 has an upper edge 180 that is wider than a lower edge 182.

As shown in FIG. 6, the upper edges 180 of the pair of scapular bladders 124 are generally parallel as well as are collinear. The upper edge 180 of the scapular bladder 124 is positioned adjacent the top surface 144 of the seat back frame 116. As also shown in FIG. 6, the scapular bladders 124 extend above the thoracic bladder 128. As such, the upper edge 180 of each of the scapular bladders 124 is positioned above the thoracic bladder assembly 26. In one embodiment, the upper edge 180 of each of the scapular bladders 124 is positioned in the range of 10 mm to 40 mm above the thoracic bladder assembly 26. In another embodiment, the upper edge 180 is positioned in 20 mm to 25 mm above the thoracic bladder assembly 26.

The scapular bladders 124 have an angled inner edge 186 and outer edge 188. The inner edge 186 may be generally parallel to the lateral edge 190 of the thoracic bladder assembly 126 that has a tapered and expanding width in the longitudinal direction.

As shown in FIG. 6, the pair of scapular bladders 124 are spaced apart by the thoracic bladder assembly 26. The scapular bladders 124 are oriented as mirror images about the central axis 140 of the seat back 112. As such, inner side edges 186 of the pair of bladders 124 are not parallel. As shown in FIG. 6, the inner side edges 186 of the pair of bladders 124 are oriented at acute angles relative to each other. In at least one embodiment, the lower edge 182 may be defined by the intersection of the side edges 186, 188 so that the scapular bladder 124 is shaped as an irregular triangle.

With continued reference to FIG. 6, a lumbar zone air bladder assembly 160 is provided below the thoracic air bladder assembly 126 to support the lower back at the L1 to L5 vertebrae. The lumbar zone air bladder assembly 160 includes right and left bladders 162, 163 that abut along the central axis of the seat and are mirror images, according to an embodiment.

Also shown in FIG. 6, a pair of sacral zone air bladders 142 are provided below the lumbar air bladder assembly 160 to support the sacral regions of the occupant. The sacral zone air bladder may be provided as single air bladder.

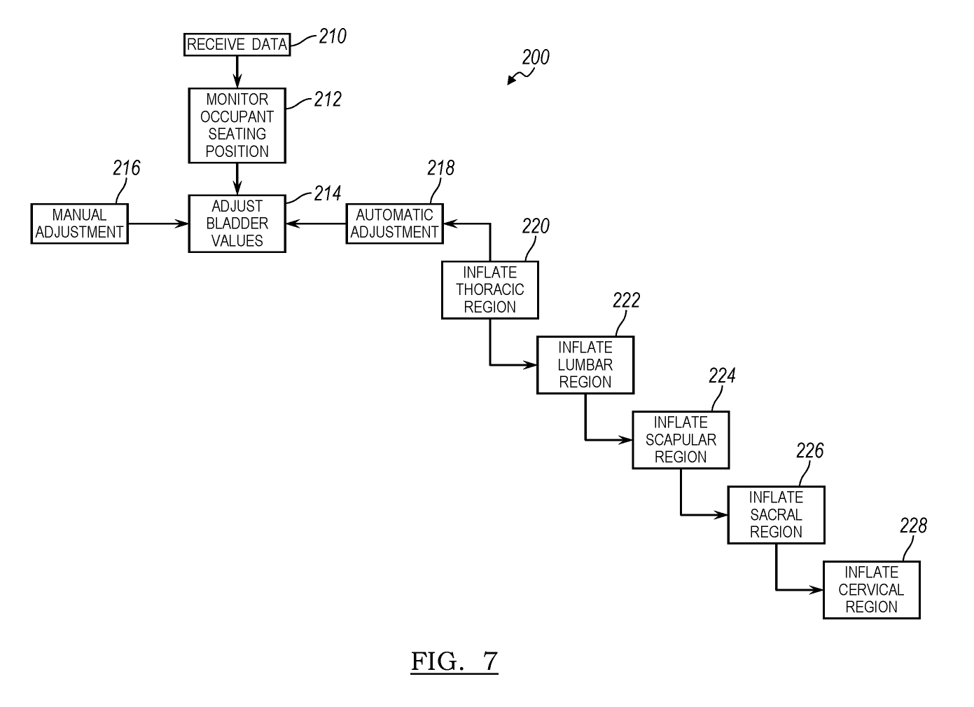

The controller 40 controls inflation of the bladders in the support system to provide various adjustment positions of a vehicle seat assembly 10 for various users, as described in U.S. application Ser. No. 14/575,474, incorporated by reference in its entirety by reference herein. FIG. 7 depicts a flowchart for a method 200 for adjusting the seat assembly 10 according to an embodiment.

At block 210, the controller 40 includes data or is programmed to collect and receive data. The data may include expert positioning of a suitable sample of occupants for optimal comfort or preferred posture by a medical professional. The expert input provides a high level of expert comfort, posture and personalized fitting. The data may be based on anthropometry, body pressure distribution (BPD), status of actuators (such as pressure of inflatable air bladders, status of valves or the like), or other data that provides a comfort, posture and biomechanically optimized position of the adjustable vehicle seat assembly.

The data may also include occupant specific data input by the occupant on a user interface, for example. The data is collected in a knowledge base or table for setting adjustments based on categories of data. The setting adjustments from the knowledge base are utilized for pre-set options in the vehicle seat assembly. The setting adjustments can be customized by a user interface or display. The interface may be integrated into the vehicle, such as an instrument panel display that is in suitable wired or wireless communication with the controller 40. The interface may be remote, such as a personal digital assistant (PDA) including phones, tablets and the like. The interface may be provided as a smart device application, wherein users enter relevant information about themselves. The smart phone interface may not require on-site expertise or seat properties. The remote interface permits a user to transport settings to each vehicle, such as personal passenger vehicles, airline seating, rental cars, and the like.

At block 212 the controller monitors the occupant seating position. Each of the bladders in the inflatable support system may include a pressure sensor to detect air pressure in the respective bladders. Any pressure sensor is contemplated, such as a pneumatic pressure sensor at the outlet valve of each respective air bladder. Pressure can also be sensed by contact pressure sensors disposed in front of or behind some or all the respective air bladders, including on a front or rear surface thereof. The contact pressure sensors may include pressure-sensing mats, for example, or any suitable contact sensor. The controller 40 may receive an occupant weight distribution from the air bladder pressure sensors.

The controller 40 compares the sensor values, and if the controller 40 determines that the occupant is not seated evenly or in a proper neutral position, the controller 40 adjusts the bladder values, as shown in block 214. The controller 40 may adjust the air pressure in the bladders to balance the occupant seating position. Steps 212 and 214 may be repeated for dynamically and incrementally adjusting the inflatable support system to adjust the occupant's position.

The adjustment may be manual adjustment, as shown at block 216. The bladders of the support system may be manually adjusted where the occupant can select a region of the seat for adjustment, such as scapular support, cervical support, thoracic support or other support regions such as lumbar support or side support, to adjust the pressure and inflation setting. As block 218, the support system may also be automatically adjusted based on the measurements from the pressure sensors and the anthropometric data, for example.

The automatic adjustment of the bladders of the inflatable support system may be a sequential adjustment. The bladders are inflated in a sequence to support posture alignment, posture support and movement. Misalignments of spinal vertebrae and discs may cause irritation to the nervous system and may be an underlying cause to many health problems. Additionally, spinal misalignments can be a contributing factor to a herniated disc, a bulging disc, a facet joint problem, osteoarthritis and spinal stenosis.

The sequence can be controlled by the seat controller 40. Initially, as shown in block 220, the thoracic air bladder assembly is inflated. The thoracic air bladders may be inflated individually or simultaneously. Next, at block 222, the lumbar air bladders are inflated thereby supporting the lumbar vertebrae.

Subsequently, at block 224, the scapular bladders are inflated for scapular support. The scapular bladders are inflated to further lift the upper back region and pull the shoulder blades of the occupant up and rearward to help prevent slouching and a rounded upper. Subsequently, at block 226, the sacral air bladders are inflated for sacrum pressure to promote a slight forward tilt of the sacrum and pelvis.

Next, at block 228, the cervical bladder is inflated to support the neck and thoracic-cervical junction as the occupant is induced to straighten their back and sit upright in a more neutral posture.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seat assembly comprising:
a seat back;
a central bladder assembly oriented in a thoracic region of the seat back;
a pair of side bladders each positioned on a lateral side of the central bladder assembly oriented in a scapular region of the seat back;
an inflation device in fluid communication with the central bladder assembly and the pair of side bladders; and
a controller in electrical communication with the inflation device programmed to:
operate the inflation device to inflate the central bladder assembly; and
operate the inflation device to inflate the pair of side bladders after initiating inflation of the central bladder assembly.

2. The seat assembly of claim 1 further comprising an upper bladder positioned above the central bladder assembly in an upper spinal region and positioned laterally between the pair of side bladders, the upper bladder at least partially oriented in a cervical region of the seat back,
wherein the controller is further programmed to:
operate the inflation device to inflate the upper bladder after initiating inflation of the pair of side bladders.

3. The seat assembly of claim 2 further comprising:
a lumbar bladder positioned below the central bladder assembly in a lumbar region;
wherein the controller is further programmed to:
operate the inflation device to inflate the lumbar bladder before initiating inflation of the pair of side bladders.

4. The seat assembly of claim 3 further comprising:
a pair of sacral bladders spaced apart laterally and positioned in a sacral region of the seat back,
wherein the controller is further programmed to:
operate the inflation device to inflate the pair of sacral bladders after initiating inflation of the lumbar bladder.

5. An air bladder assembly for a seat back comprising:
a central bladder assembly having an increasing width in a longitudinal direction; and
a pair of side bladders each positioned on a lateral side of the central bladder assembly and having a tapered width decreasing in the longitudinal direction.

6. The air bladder assembly of claim 5 further comprising an upper bladder positioned above the central bladder assembly.

7. The air bladder assembly of claim 5 wherein the central bladder assembly comprises a central region and a pair of lateral regions extending from opposed sides of the central region wherein the pair of lateral regions are oriented at a non-zero angle to incline laterally.

8. The air bladder assembly of claim 5 wherein an inner edge of each of the side bladders is positioned adjacent to the central bladder assembly along each lateral side.

9. The air bladder assembly of claim 5 wherein the central bladder assembly is positioned to be symmetric about a central longitudinal axis of the seat, and wherein the pair of side bladders are oriented as mirror images about the central longitudinal axis.

10. The air bladder assembly of claim 9 further comprising an upper bladder positioned laterally between the pair of side bladders and above the central bladder assembly, the upper bladder symmetric about the central longitudinal axis.

11. The air bladder assembly of claim 5 wherein the support surface of each of the side bladders is reclined along the longitudinal direction when inflated.

12. The air bladder assembly of claim 5 wherein the pair of side bladders are spaced apart by at least 60 millimeters.

13. A seat assembly comprising a seat back and an air bladder assembly according to claim 5 oriented within the seat back.

14. An air bladder assembly for a seat back comprising:
a pair of scapular bladders spaced apart laterally, each scapular bladder having a support surface shaped as an irregular quadrilateral,
wherein the pair of scapular bladders are oriented as mirror images of each other about a central longitudinal axis of the seat.

15. The air bladder assembly of claim 14 wherein each scapular bladder has a lower edge that is more narrow than an upper edge.

16. The air bladder assembly of claim 15 wherein the lower edge expands in a fore-aft direction a greater distance than the upper edge so the support surface is reclined in the fore-aft direction when inflated.

17. The air bladder assembly of claim 14 further comprising a thoracic bladder assembly positioned between the pair of scapular bladders.

18. The air bladder assembly of claim 17 wherein the thoracic bladder assembly has an increasing width in a longitudinal direction, wherein an inner edge of each of the scapular bladders is positioned adjacent to the thoracic bladder assembly along each lateral side.

19. The air bladder assembly of claim 14 further comprising a cervical bladder positioned laterally between the pair of scapular bladders.

20. A seat assembly comprising a seat back and an air bladder assembly according to claim 14 oriented within the seat back.
